(19) United States
(12) Patent Application Publication
(10) Pub. No.: US 2008/0248233 A1
(43) Pub. Date: Oct. 9, 2008

(54) Tobacco Suction Tape

(76) Inventors: Mark J. Levine, Hendersonville, TN (US); Manish Jain, Homer, NY (US); Daniel Fadel, Groton, NY (US)

Correspondence Address: FROMMER LAWRENCE & HAUG, 745 FIFTH AVENUE- 10TH FL., NEW YORK, NY, 10151, US

(21) Appl. No.: 12/045,166

(22) Filed: Mar. 10, 2008

Related U.S. Application Data
(60) Provisional application No. 60/918,121, filed on Mar. 15, 2007.
(60) Provisional application No. 60/978,991, filed on Oct. 10, 2007.

(51) Int. Cl. B32B 3/10; B32B 3/30; B32B 37/04

(52) U.S. Cl. 428/58; 156/252; 156/272.8; 428/131

(57) ABSTRACT

Briefly the invention relates to a tobacco conveyer belt, for example a suction tape with improved mechanical properties. More specifically, the present invention is directed to an endless suction tape that is formed from a continuous polymeric film containing a polymer chosen to maximize the wear resistance and minimize toxicity of any polymer contaminating the tobacco. The tape is permeable and perforated according to a desired distribution. The suction tape can be formed with a uniform texture, by embossing mechanically, ultrasonically, or through a laser removal technique. Either or both surfaces of the tape can be smooth or textured.

### CROSS-REFERENCE TO RELATED APPLICATIONS

This application claims priority benefits of U.S. Provisional Patent Application Ser. No. 60/918,121 filed Mar. 15, 2007 and U.S. Provisional Patent Application Ser. No. 60/978,991 filed Oct. 10, 2007, the disclosures of which are hereby incorporated by reference.

### BACKGROUND

1. Field of the Invention

This invention relates generally to tobacco conveyor belts for use in the manufacture of cigarettes and the like. More specifically, but not exclusively, the present invention is directed to suction tapes for conveying tobacco in a manufacturing machine.

2. Background Discussion

The invention relates to conveyer belts used in machines for the production of rod-shaped commodities wherein a stream of filler of fibrous material is confined in a tubular wrapper. Typical examples of such machines are those which are used to make cigarette rods, filter rods and similar rods which can be subdivided into rod-shaped articles (such as cigarettes, cigars, cigarillos or filter rod sections) of the tobacco processing industry. The following description will deal primarily or exclusively with the making of cigarettes; however, it is to be understood that the invention can be embodied with equal or similar advantage in other types of rod making machines, especially those which are used to manufacture rod-shaped smokers' products.

During the manufacture of cigarettes, a measured quantity of tobacco is taken up from a first tobacco conveyor belt by a second tobacco conveyor belt, i.e. the so-called suction tape, which generally has a width in the range from 0.5 to 1.5 cm. A diagrammatic illustration of a machine for making cigarettes is shown in FIG. 1. Each disposed line of tobacco is urged from the first tobacco conveyor belt 1 against the underside of a suction tape 2. The suction tape 2 runs within a groove in a suction box 3, the base of the groove being defined by a recessed ladder-like structure defined by two or more longitudinal rods linked together at spaced intervals by bars. The suction box 3 ensures that the suction tape 2 is urged upwardly against the recess ladder-like structure so that the tobacco is urged against the underside of the suction tape 2. The tobacco rod thus formed is removed from the suction tape 2 by means of inclined scraper blades 5, whereupon it falls onto enveloping cigarette paper supplied on a further conveyor belt, i.e. the so-called garniture belt 4.

The suction tape 2 is generally subjected to a vacuum in the suction box 3. Tobacco fibers spread out in a distributor are “upward-showered” by this vacuum from below onto the continuous suction rod conveyor; the suction tape 2. The air current passing through the air permeable tape to the vacuum chamber guides the tobacco fibers from the tobacco “shower” to the tape, and suspends them from this tape until they are deposited as a fiber rod onto the cigarette paper at the format intake. The high machine speed means that the tape must have a high permeability and sufficient surface roughness in order to achieve efficient conveyance of the tobacco rod. This suction tape must withstand extreme stresses, since on the one hand operation with minimum textile substance is necessary in order to achieve high air permeability, and on the other hand the tape is subjected to very high wear by the high operating speed of over 600 m/min. As a result of these conditions it is possible that fibers/particles of the tape can get separated and get into the tobacco, impairing its flavor, and/or adding a potentially toxic component when burned.

The use of suction tapes, or so-called “foraminous belts”, used to convey and deposit tobacco based fibrous material in continuous measured portions onto a running web of wrapping material has also been disclosed in U.S. Pat. No. 4,721,119; U.S. Pat. No. 5,072,742 and U.S. Pat. No. 5,649,551, which describe the cigarette manufacturing process more in detail and whose teachings are incorporated herein by reference.

Conventional suction tapes are woven endless, or alternatively are flat woven and then joined by ultrasonic means. Typically a single continuous weft (cross machine direction or merely “CD”) yarn is provided, thus presenting a large number of selvages at the fabric edges. The selvages are highly susceptible to abrasion, accelerating fabric failure. The bunched nature of the warp (machine direction or merely “MD”) yarns results in a somewhat non-uniform tape permeability and therefore a less even distribution of tobacco.

An example of a typical suction tape is shown in FIG. 2. It is known in the art to use a conveyor tape that comprises loose warp yarns 20 or loose weft yarns 10 and is reinforced at the selvage and in the center of the tape by an increased set (number) of the warp yarns 20 (French Patent FR 1238895), as shown in FIG. 2. The tape is stretched under tension in a final process and heatset at a temperature between 100° C. and 120° C. in the stretched condition by fixing the stretched polymer yarns.

Tobacco suction tapes are typically produced as either monofilament woven fabric or alternatively, perforated steel tapes (shown in FIG. 3). Monofilament woven tapes suffer from deficiencies, such as:

1. Single CD monofilament weft yarns results in poor abrasion resistance and therefore the tape has the potential for large, visible portions of monofilament to break off and deposit into the tobacco stream during the cigarette making process.

2. Construction is generally “loose”, which creates a non-uniform distribution of MD monofilament yarns. This results in weight distribution variation in both MD and CD, causing deposition variation in the formed cigarettes.

3. Melt or resinous bonds are required to create an endless tape structure. These bonds are the weakest portion of the tape loop (failure points) and are typically regions of zero permeability, which also effect deposition variation.

On the other hand, perforated steel tapes suffer from deficiencies, such as:

1. Flex fatigue of the metal limits life of the tape as compared to that of their polymeric monofilament woven counterpart.

2. Limits to surface texture, even with embossed versions, subsequently limit operational running speeds. Thus steel tapes are limited to low and medium speed machines.

Although attempts have been made to improve these designs, most have fallen short due to insufficient benefits or high cost and poor consequent economic feasibility. Such attempts are disclosed in commonly known U.S. Pat. No. 5,119,938 to Beckh et al. and U.S. Pat. No. 5,857,561 to Hardman et al., whose teachings are incorporated herein by reference.

U.S. Pat. No. 5,119,938 relates to a continuous woven conveyor tape that includes carrier fibers and melt bondable fibers in the mesh. The bonding points, herein, are achieved by melting of the intersection points arranged in linear fashion, preventing the separation of individual fiber particles. These bond points, however, are the weakest portions of the tape loop because they are prone to failure, and are typically regions of zero permeability, which also effect tobacco deposition variation, as discussed earlier.

U.S. Pat. No. 5,857,561 relates to a suction tape having a regular nonwoven extruded mesh structure that incorporates an ultraviolet sensitive material and a reinforcing yarn wholly embedded in lands of the mesh, running in the intended running direction of the tape in order to support fiber reinforcement. This structure, however, results in poor abrasion resistance due to its material structure and therefore has potential for large, visible portions of nonwoven to wither off and become deposited in the tobacco stream during transfer.

Accordingly, the present invention is aimed at overcoming the drawbacks of the prior art discussed above and therefore serves as an advancement in the state of the art. The present invention therefore relates to a suction tape with improved properties such as higher abrasion or wear resistance, low deposition variability, improved dimensional stability, and increased tape life.

### SUMMARY OF THE INVENTION

Briefly the invention relates to a tobacco conveyer belt, for example a suction tape with improved mechanical properties. More specifically, the present invention is directed to an endless suction tape that is formed from a continuous polymeric film containing a polymer chosen to maximize the wear resistance of the suction tape. The tape is permeable and perforated according to a desired distribution and pattern.

Accordingly, an object of the present invention is to provide a suction tape with high abrasion resistance with abraded product loss limited to fine particles/dust.

Another object of the present invention is to provide a suction tape comprising material, which if abraded off and contaminates the tobacco, minimizes toxicity during combustion when smoking a cigarette.

Yet another object of the present invention is to provide a suction tape with improved wear resistance.

Yet another object of the present invention is to provide a suction tape with a uniform texture, which is created via embossing mechanically, ultrasonically, or through a laser removal (ablation) technique. Either or both surfaces of the tape can be smooth or textured, and the texture on one surface can be different from that on the other surface.

Yet another object of the present invention is to provide a suction tape with improved permeability uniformity, achieved via perforation that is carried out mechanically, ultrasonically, or through laser removal (ablation) techniques.

Yet another object of the present invention is to provide a suction tape made endless with a durable, flexible and permeable bond, achieved via an ultrasonic or laser bonding technique.

Yet another object of the invention is to provide a suction tape with uniform deposition performance in the bond area of the tape that is equal to the rest of the body of the suction tape.

Yet another object of the present invention is to provide a suction tape that conveys more efficiently compared to a woven tape, and with low deposition variability.

Yet another object of the present invention is to provide a suction tape that has increased dimensional stability with a homogenous material devoid of any reinforcements (additional contaminants/sources of contamination or delamination).

Other embodiments of the present invention include suction tapes described above but implemented using different materials or material combinations, with either or both surfaces of the suction tape being smooth or textured.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a conventional cigarette making machine;

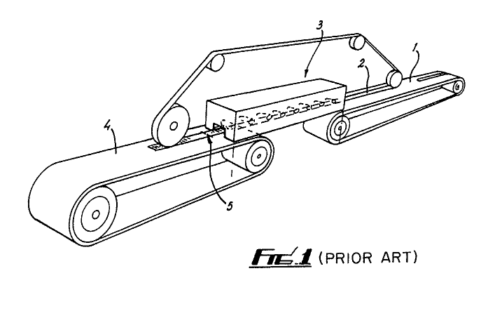

FIG. 2 illustrates a suction tape disclosed the in prior art;

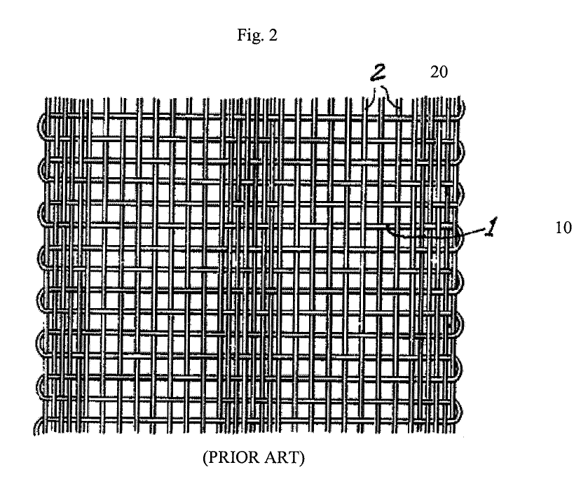

FIG. 3 illustrates a perforated steel suction tape disclosed in the prior art; and

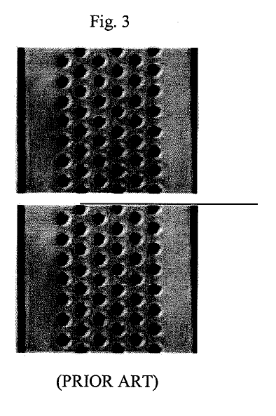

FIG. 4 is a profile view of a suction tape, according to one aspect of the invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description.

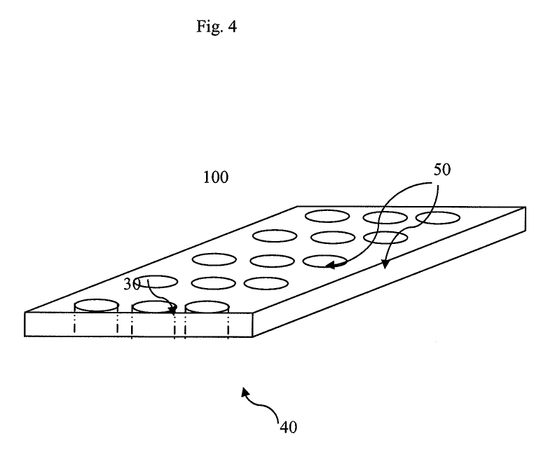

The invention according to one of its embodiments is a tobacco conveyer belt, such as an engineered suction tape 100, as shown in FIG. 4. The tape 100 is formed from a continuous oriented polymeric film containing a polymer chosen to maximize wear resistance of the tape and to minimize toxicity if abraded particles contaminate the tobacco rod. Preferred materials that can be used to form the tape 100 of the present invention and those that cause the least toxicity under combustion are e.g., inorganic polymers; organic polymers formed from only carbon, hydrogen and oxygen with no aromatic moieties; or high temperature, thermally stable polymers formed from only carbon, hydrogen and oxygen which will retard the rate of toxic off-gassing; or other polymers such as polyamide (PA 6; PA 6,6; PA 6,10; PA 6,12; hybrid PA 6,T etc.), polyimide, polyetherimide (Ultem®) and polyester (PET, PBT, PEN etc.). In the class of non-aromatic organic polymers, which may be used to form the tape 100 of the present invention, are for example: polylactic acid (PLA), cellulose acetates, cellulose propionate, olefins including ultra-high molecular weight (UHMW) versions, polyethylene glycols, acrylics, and ethylene vinyl acetates. Polyketones, such as polyether ether ketone (PEEK) are a class of polymers which are examples of high temperature, thermally stable polymers, which can be used to extrude the tape 100 of the instant invention. Polyphosphazenes are also an example of a class of inorganic polymers, which can be fabricated into the instant tape 100.

The tape 100 is perforated and made permeable by creating through holes or pores 50 in the tape, according to a desired distribution, density, and/or arrangement. The holes 50 can be formed of any shape, size or orientation density or pattern suitable for the purpose. Desired permeability is achieved by perforating the tape 100 mechanically, ultrasonically, or by using a laser removal (ablation) technique. The tape 100 has a top surface 30 and a bottom surface 40 onto which the tobacco fibers are transferred. Either or both surfaces 30, 40 can be smooth or textured as desired. Uniform texture can be created by embossing the tape 100 mechanically, ultrasonically, or by laser removal (ablation or etching) technique. The tape, if not already endless, is then made endless by overlapping the two CD edges of the tape and fusing them, making the tape endless. Durable, flexible, and permeable bonds are achieved by ultrasonic or laser bonding/seaming techniques. The bond area is also perforated in the same manner as the tape body.

The advantages of the suction tape, thus formed are:
High abrasion resistance with abraded product loss limited to fine particles/dust.
Conveying efficiency of a woven tape, with the low deposition variability of a highly uniform structure.
Dimensional stability which is achieved with a homogenous material that is devoid of any reinforcements (additional contaminants/sources of contamination or delamination).
Deposition performance in the bond area, which is equal to the rest of the body of the tape.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A tobacco suction tape comprising:
a nonreinforced polymeric film having a top surface and a bottom surface,
wherein the polymeric film comprises a plurality of through holes, according to a desired density and/or pattern.

2. The tobacco suction tape as claimed in claim 1, wherein the suction tape is formed of a polymer selected from the group consisting of:
i) inorganic polymers including polyphosphazenes;
ii) organic polymers which have only carbon, hydrogen and oxygen with no aromatic moieties;
iii) high temperature, thermally stable polymers formed from only carbon, hydrogen and oxygen;
iv) non-aromatic organic polymers such as polylactic acid (PLA), cellulose acetates, cellulose propionate, polyketones such as polyether ether ketone (PEEK), olefins including ultra-high molecular weight (UHMW) versions, polyethylene glycols, acrylics, and ethylene vinyl acetates; and
v) polyamide (PA 6; PA 6,6; PA 6,10; PA 6,12 and hybrid PA 6,T), polyimide, polyetherimide, polyethylene terephthalate (PET), polybutylene terephthalate (PBT) and polyethylene naphthalate (PEN).

3. The tobacco suction tape as claimed in claim 1, wherein the tape is endless.

4. The tobacco suction tape as claimed in claim 1, wherein the tape is made endless by fusing together the CD edges of the suction tape.

5. The tobacco suction tape as claimed in claim 1, wherein the holes are formed of any desired shape, size or orientation.

6. The tobacco suction tape as claimed in claim 1, wherein the holes are formed by perforating the suction tape mechanically, ultrasonically, or by using a laser removal technique.

7. The tobacco suction tape as claimed in claim 1, wherein either or both surfaces of the tape are smooth.

8. The tobacco suction tape as claimed in claim 1, wherein either or both surfaces of the tape are textured.

9. The tobacco suction tape as claimed in claim 8, wherein the texture is created by embossing the suction tape mechanically, ultrasonically, or by laser removal technique.

10. The tobacco suction tape as claimed in claim 4, wherein the fusing is done by ultrasonic or laser bonding techniques.

11. A method of forming an endless tobacco suction tape, comprising the steps of:
forming a polymeric nonreinforced film, and
perforating the suction tape with a plurality of through holes, according to a desired density and/or pattern.

12. The method as claimed in claim 11, wherein the suction tape is formed of a polymer selected from the group consisting of:
i) inorganic polymers including polyphosphazenes;
ii) organic polymers formed from only carbon, hydrogen and oxygen with no aromatic moieties;
iii) high temperature, thermally stable polymers with only carbon, hydrogen and oxygen;
iv) non-aromatic organic polymers such as polylactic acid (PLA), cellulose acetates, cellulose propionate, polyketones such as polyether ether ketone (PEEK), olefins including ultra-high molecular weight (UHMW) versions, polyethylene glycols, acrylics, and ethylene vinyl acetates; and
v) polyamide (PA 6; PA 6,6; PA 6,10; PA 6,12 and hybrid PA 6,T), polyimide, polyetherimide, polyethylene terephthalate (PET), polybutylene terephthalate (PBT) and polyethylene naphthalate (PEN).

13. The method as claimed in claim 11, further comprising the step of making the tape endless by fusing together CD edges of the suction tape.

14. The method as claimed in claim 11, wherein the holes are formed of any desired shape, size or orientation.

15. The method as claimed in claim 11, wherein the holes are formed by perforating the suction tape mechanically, ultrasonically, or by using a laser removal technique.

16. The method as claimed in claim 11, further comprising the step of providing a smooth surface on one of either or both surfaces of the tape.

17. The method as claimed in claim 11, further comprising the step of providing a textured surface on one or both surfaces of the tape.

18. The method as claimed in claim 17, wherein the texture is created by embossing the suction tape mechanically, ultrasonically, or by laser removal technique.

19. The method as claimed in claim 13, wherein the fusing is done by ultrasonic or laser bonding techniques.
